(19) United States
(12) Patent Application Publication
(10) Pub. No.: US 2021/0148335 A1
(43) Pub. Date: May 20, 2021

(54) WIND TURBINE STEEL TOWER SECTION FOR A WIND TURBINE TOWER AND METHOD FOR THE PRODUCTION THEREOF

(71) Applicant: Wobben Properties GmbH, Aurich (DE)

(72) Inventors: Roy KERSTEN, Hohenwarthe (DE); Ronald LANGE, Leipzig (DE); Britta RANDEL, Derben (DE)

(21) Appl. No.: 16/633,919

(22) PCT Filed: Jul. 18, 2018
(86) PCT No.: PCT/EP2018/069537

§ 371 Date: Jan. 24, 2020

(30) Foreign Application Priority Data
Jul. 26, 2017 (DE) 10 2017 116 872.9

(51) Int. Cl. F03D 13/20; E04H 12/08

(52) U.S. Cl. CPC F03D 13/20; F05B 2230/60; F05B 2240/912; E04H 12/085

(57) ABSTRACT

A wind turbine steel tower portion, to a wind turbine tower, to a wind turbine and to a method for producing a wind turbine steel tower portion. A wind turbine steel tower portion for a wind turbine tower, comprising a first wind turbine steel tower ring segment with a first vertical joint side, a second wind turbine steel tower ring segment with a second vertical joint side, a bracket element which is arranged at a joint and which is connected to the first wind turbine steel tower ring segment and to the second wind turbine steel tower ring segment, wherein the first wind turbine steel tower ring segment, with the first vertical joint side, and the second wind turbine steel tower ring segment, with the second vertical joint side, are arranged against one another at the joint, and wherein the bracket element has a connection element which projects from the bracket element and which serves for the arrangement of functional elements.

### BACKGROUND

### Technical Field

The invention relates to a wind turbine steel tower portion, a wind turbine tower, a wind turbine and a method for producing a wind turbine steel tower portion.

### Description of the Related Art

Wind turbines are fundamentally known. Modern wind turbines generally concern so-called horizontal-axis wind turbines, in the case of which the rotor axis is oriented substantially horizontally and the rotor blades sweep through a substantially vertical rotor area during operation. Aside from a rotor arranged at a nacelle, wind turbines generally comprise a tower on which the nacelle with the rotor is arranged so as to be rotatable about a substantially vertically oriented axis.

Towers are generally slim structures which preferably have a large height and which furthermore preferably have relatively small dimensions orthogonally with respect to this height. Towers are preferably composed substantially of concrete and/or steel or comprise these materials. The range of tower designs extends from lattice structures or steel tubular towers with or without cable bracing to concrete structures. A preferred construction of wind turbine towers comprises a lower tower portion composed of concrete and/or steel-reinforced concrete and/or prestressed concrete and an upper tower portion composed of steel.

Steel tubular towers may comprise a single component or two or more components or comprise such components. Towers may furthermore have cylindrical and/or conical tower portions, in particular along their longitudinal extent, wherein towers often comprise cylindrical and conical tower portions. Furthermore, such tower portions may also be formed in the manner of ring segments, such that a tower portion is made up of different, mutually adjacently arranged segments in the ring direction or circumferential direction.

Towers of wind turbines, in particular of modern horizontal-axis wind turbines, account for a major part of the total costs of manufacturing a wind turbine. In particular, the increasing rotor diameters and power outputs of wind turbines mean that the towers are also becoming larger and/or are being subjected to higher loads. Towers are becoming larger firstly in terms of their height and secondly in terms of their diameter, which in many modern wind turbines is already 8 meters or greater. In particular, the manufacture and/or assembly and/or logistics of the towers is or are time-consuming and expensive. In particular in the case of segmented steel towers, in particular in the case of steel towers which are segmented in a circumferential direction, distortion is often found, which complicates the assembly of the tower.

In the prior art, there are various approaches for reducing the costs and increasing working safety during the manufacture and/or assembly of wind turbine towers. For example, DE 10 2011 077 428 A1 describes a wind turbine tower with a plurality of tower segments, the tower segments abutting against one another at horizontal and vertical flanges and being fastened to one another here. In the German patent applications filed by this applicant on Aug. 8, 2016 and Mar. 22, 2017, different concepts of segmented towers are presented. By contrast, DE 10 2005 012 497 A1 proposes a working platform for an interior of a wind turbine tower, which working platform can be used in the interior of a tower-like structure even if the tower is closed at the top by a superstructure. DE 20 321 855 U1 presents a steel tower which is segmented in a circumferential direction, wherein the mutually adjacently arranged segments have vertical flanges.

The existing systems and methods for building and manufacturing wind turbine towers offer various advantages, but further improvements are desirable. The German Patent and Trademark Office has searched the following prior art in the priority application relating to the present application: DE 10 2011 077 428 A1, DE 10 2005 012 497 A1, DE 203 21 855 U1, EP 2 006 471 B1 and DE 11 2010 005 382 T5.

### BRIEF SUMMARY

Provided a wind turbine steel tower portion, a wind turbine tower, a wind turbine and a method for producing a wind turbine steel tower portion which may alleviate or eliminate one or more of the stated disadvantages. Provided is a solution that simplifies the assembly of a wind turbine and/or reduces the costs thereof. Provided are techniques which reduces the costs of a wind turbine, in particular the costs of manufacturing and/or assembling a wind turbine tower, and/or increases working safety during the manufacture and/or assembly of a wind turbine.

Provided is a wind turbine steel tower portion for a wind turbine tower, comprising a first wind turbine steel tower ring segment with a first vertical joint side, a second wind turbine steel tower ring segment with a second vertical joint side, a bracket element which is arranged at a joint and which is connected to the first wind turbine steel tower ring segment and to the second wind turbine steel tower ring segment, wherein the first wind turbine steel tower ring segment, with the first vertical joint side, and the second wind turbine steel tower ring segment, with the second vertical joint side, are arranged against one another at the joint, and wherein the bracket element has a connection element which projects from the bracket element and which serves for the arrangement of functional elements.

The wind turbine steel tower portion preferably has a ring-shaped geometry, such that it has an at least partially closed wall in a circumferential direction. If the wind turbine steel tower portion has a total of two wind turbine steel tower ring segments, it is particularly preferable for the wind turbine steel tower ring segments to each have an extent of 180° in the circumferential direction. The wind turbine steel tower portion may also have three or more wind turbine steel tower ring segments, which are preferably each connected to a bracket element described above. In particular, it is preferable for the wind turbine steel tower portion to have a total of eight wind turbine steel tower ring segments. The wind turbine steel tower portion may thus have a ring-shaped or part-ring-shaped geometry.

The wind turbine steel tower ring segments preferably comprise shell segments. It is furthermore preferable for the wind turbine steel tower ring segments to each have an extent in the direction of a segment height, of a segment ring direction and of a segment thickness. The segment ring direction may also be understood as a circumferential direction, wherein a wind turbine steel tower ring segment extends in particular between the two vertical joint sides in the segment ring direction. The segment thickness is generally the material thickness.

In the installed state, the segment height of the wind turbine steel tower ring segment is oriented preferably and substantially parallel to a longitudinal axis of the wind turbine tower. Deviations from ideal parallelism are possible, because a wind turbine steel tower ring segment for a conical tower portion has a segment height oriented in this way, which may be inclined in relation to the longitudinal axis of the wind turbine tower. In the installed state, the segment ring direction runs substantially parallel to the circumferential direction of the wind turbine tower, such that said segment ring direction runs in a substantially tangential direction. This also applies to non-circular tower cross sections, which may for example have a polygonal geometry. The segment thickness is oriented substantially orthogonally with respect to the segment height and with respect to the segment ring direction, such that the segment thickness is oriented substantially in a radial direction of the wind turbine tower in the installed state.

The first vertical joint side of the first wind turbine steel tower ring segment and the second vertical joint side of the second wind turbine steel tower ring segment are oriented substantially vertically in the installed state. In order to allow for a tapered geometry of wind turbine towers, the first vertical joint side and/or the second vertical joint side may also have a slightly inclined and thus slight deviation from the ideal vertical. The first vertical joint side and/or the second vertical joint side extend preferably in certain portions or entirely in each case along one side of the first wind turbine steel tower ring segment and/or of the second wind turbine steel tower ring segment. The first wind turbine steel tower ring segment and/or the first vertical joint side and/or the second wind turbine steel tower ring segment and/or the second vertical joint side are arranged and designed in such a way that they can be arranged against one another at a joint, in particular a vertical joint. In particular, they are arranged and designed in such a way that the bracket element can be connected to the first wind turbine steel tower ring segment and the second wind turbine steel tower ring segment in the region of the joint. The wind turbine steel tower portion is preferably sealed in the region of the joint. The sealing may be realized for example by means of a sealing compound or a seal.

The bracket element serves for the connection of the two wind turbine steel tower ring segments, wherein the bracket element is connected at one side to the first wind turbine steel tower ring segment and at the other side to the second wind turbine steel tower ring segment. In the operating state, the first wind turbine steel tower ring segment and the second wind turbine steel tower ring segment may be spaced apart from one another at the joint, and may in particular be held in position by the bracket element. In particular, a single-shear, double-shear and/or multi-shear connection is realized by means of the bracket element.

For example, a segment spacing between the two wind turbine steel tower ring segments may amount to 10 mm. The joint may furthermore be sealed with a suitable material. The joint may be equipped with an elastic seal from the outside, such that the cavity formed at the joint is protected against external influences. The elastic seal may for example be introduced from the outside into the gap between the two wind turbine steel tower ring segments. For example, a single-component polymer-modified sealant may be used as material for the elastic seal.

The bracket element has a connection element which projects from the bracket element and which serves for the arrangement of functional elements. The connection element is in particular arranged and designed such that supporting structures can be arranged on it. As will be described in more detail further below, the connection element may be arranged in a wide variety of ways on the bracket element, wherein said connection element may be formed as a single piece with the bracket element or may be arranged on the bracket element, for example by means of welding and/or a further element.

The invention is based inter alia on the knowledge that the welding of supporting structures to the surface-forming walls, in particular the shell segments, of wind turbine steel tower ring segments often results in distortion of precisely these wind turbine steel tower ring segments. In addition, the material properties of the steel are changed by the introduction of heat during the welding process, such that the wind turbine steel tower ring segment possibly no longer has the material properties, such as strength and/or hardness, that were originally defined and set. The distortion of the shell segment also results in significantly more complex assembly, since the wind turbine steel tower ring segments no longer have an optimal fit as a result of the distortion. This also has the result, inter alia, that the towers are placed under stress during the assembly process, and this stress leads to possibly undesired stress conditions in the tower.

These disadvantages can be alleviated or eliminated by means of a bracket element designed and arranged with a projecting connection element, wherein the connection element projects from the bracket element. Various further devices and/or units and/or elements can then be fastened to this connection element, such that these devices and/or units and/or elements that previously had to be arranged in the shell segment can now be fastened directly to the connection element, and are therefore no longer welded directly to the shell segment.

The connection element has the particular advantage that functional elements can be arranged here at low cost. Such functional elements may for example be supporting structures on which assembly pedestals are arranged. Furthermore, supply devices such as cables or cable harnesses or cable harness holding devices may also be arranged on the connection elements. A further advantage of the bracket element with a projecting connection element is the possibility of series manufacture of the bracket element with the projecting connection element, such that costs can be reduced further here.

In a preferred design variant of the wind turbine steel tower portion, provision is made whereby the first wind turbine steel tower ring segment and/or the second wind turbine steel tower ring segment has or have a part-ring-shaped cross section, wherein a surface normal of said cross section is oriented substantially parallel to the segment height, and the part-ring-shaped cross section has a part-circle-shaped profile, and/or the part-ring-shaped cross section is formed by two or more straight portions, wherein the two or more straight portions enclose a bend angle. The bend angle preferably amounts to 175° or 174°. A wind turbine steel tower ring segment which is bent in this way is preferably produced by means of a 180 mm bending die.

In a further preferred design variant of the wind turbine steel tower portion, provision is made whereby the bracket element and the connection element enclose a connection angle, and/or the connection element projects in a projecting direction and the projecting direction is oriented substantially radially.

When a connection angle is enclosed by the bracket element and the connection element, the connection element has in particular a main extent direction which has at least one directional component which is oriented orthogonally with respect to an areal extent of the bracket element. The radial orientation of the projecting direction of the connection element is directed in particular in relation to a wind turbine steel tower portion of ring-shaped form. In the case of a wind turbine steel tower portion of ring-shaped form, the radial direction is to be understood in particular as being aligned in the radial direction of the tower to be built.

A further preferred development of the wind turbine steel tower portion is distinguished by the fact that the connection element is formed as a single piece with the bracket element, and/or the connection element is connected to the bracket element. In the case of the single-piece form of the bracket element and of the connection element, it is particularly preferable for the connection element to be formed by a bend of the bracket element. This may for example be realized by bending a portion of the starting material for the bracket element and the connection element. It is furthermore preferable for the connection element to be connected cohesively to the bracket element, in particular by welding. Furthermore, the connection element may be connected to the bracket element by means of at least one fastening element, for example a screw.

It is furthermore preferable that the connection element has a fastening portion, wherein the connection element is connected to the fastening portion, and/or the connection element is formed as a single piece with the fastening portion and is preferably formed as an angled element. The connection element is connected to the fastening portion preferably cohesively, for example by means of welding, and/or by means of fastening elements. The angled element is preferably fastened by means of the fastening portion to the bracket element, and the connection element arranged at an angle with respect thereto projects from the bracket element and from the fastening portion.

A further particularly preferred design variant of the wind turbine steel tower portion provides for the bracket element to extend from a first vertical end to a second vertical end and from an upper horizontal end to a lower horizontal end. Furthermore, a first connection element may be arranged on the first vertical end and a second connection element may be arranged on the second vertical end. In particular, it is preferable for the first connection element and the second connection element to have the same spacing to a first upper horizontal joint side and/or to a first lower horizontal joint side of the first wind turbine steel tower ring segment and/or to a second upper horizontal joint side and/or to a second lower horizontal joint side of the second wind turbine steel tower ring segment. Furthermore, the first connection element and the second connection element may have the same spacing to the upper horizontal end and/or to the lower horizontal end of the bracket element.

The vertical ends form in particular the lateral boundaries of the bracket element during operation. The horizontal ends form in particular the upper and the lower end of the bracket element. The vertical extent of the bracket element between the upper horizontal end and the lower horizontal end preferably amounts to six meters. In particular, it is preferable for the connection element to be arranged on the first vertical end and/or on the second vertical end. It is furthermore preferable for the connection element to project from the first vertical end and/or the second vertical end proceeding from the bracket element.

The connection element may extend in the direction of a connection height, of a connection width and of a connection thickness, wherein it is particularly preferable for the connection element to have a substantially areal extent owing to the extent in the direction of the connection height and of the connection width. It is furthermore preferable for the extent of the connection element in the direction of the connection height to be several times smaller than an extent of the first wind turbine steel tower ring segment and/or of the second wind turbine steel tower ring segment in the direction of a segment height oriented substantially parallel to the connection height, and/or for the extent of the connection element in the direction of the connection height to preferably be less than 20%, and/or less than 15%, and/or less than 10%, and/or less than 5%, and/or less than 2%, and/or less than 1%, and/or less than 0.1% of the extent of the first wind turbine steel tower ring segment and/or the second wind turbine steel tower ring segment in the direction of the segment height. The connection element preferably has the same material thickness as the wind turbine steel tower ring segment.

In a further preferred design variant of the wind turbine steel tower portion, provision is made whereby the bracket element is arranged on an inner circumferential surface and/or on an outer circumferential surface of the first wind turbine steel tower ring segment and of the second wind turbine steel tower ring segment. In particular, an arrangement on the inner circumferential surface of the first wind turbine steel tower ring segment and of the second wind turbine steel tower ring segment is preferred, such that a substantially continuous outer circumferential surface of the wind turbine tower that is formed is realized, which in particular satisfies esthetic requirements. It would consequently be possible for only the joints and possibly fastening elements to be visible on the outer circumferential surface of the wind turbine tower.

A further preferred development of the wind turbine steel tower portion is distinguished by the fact that the bracket element has a first bracket portion, which is arranged substantially on the first wind turbine steel tower ring segment, and/or a second bracket portion, which is arranged substantially on the second wind turbine steel tower ring segment, wherein the first bracket portion and the second bracket portion preferably enclose a bracket angle.

The bracket element preferably has a fold line which delimits the first bracket portion from the second bracket portion. The fold line may also be understood as a bending line at which the bracket element has been bent in such a way that the first bracket portion and the second bracket portion enclose the bracket angle. The fold line of the bracket element is preferably arranged parallel to the joint. The bracket element is in particular arranged and designed such that the enclosed bracket angle is oriented inward.

A further particularly preferred design variant of the wind turbine steel tower portion provides for the bracket element to be arranged with its main extent direction substantially parallel to a segment height, and for the bracket element to have, in its main extent direction, a bracket extent of more than 20%, more than 30%, more than 40%, more than 50%, more than 60%, more than 70%, more than 80%, more than 90% of the segment extent in the direction of the segment height.

The bracket element is preferably of plate-like form, the material thickness of which is oriented substantially radially and/or parallel to the material thickness of the wind turbine steel tower ring segments. In particular, it is preferable for the upper horizontal end of the bracket element to be spaced apart from the upper horizontal joint side of the first wind turbine steel tower ring segment and/or of the second wind turbine steel tower ring segment. It is furthermore preferable for the lower horizontal end to be spaced apart from the lower horizontal joint side of the first wind turbine steel tower ring segment and/or of the second wind turbine steel tower ring segment.

In a further preferred design variant of the wind turbine steel tower portion, provision is made whereby the first bracket portion is arranged on a first end portion of the first wind turbine steel tower ring segment, wherein the first end portion adjoins the first vertical joint side, and/or the second bracket portion is arranged on a second end portion of the second wind turbine steel tower ring segment, wherein the second end portion adjoins the second vertical joint side, and the first end portion and the second end portion preferably enclose a segment angle. It is furthermore preferable for the bracket element to be connected by way of the first bracket portion to the first end portion of the first wind turbine steel tower ring segment and by way of the second bracket portion to the second end portion of the second wind turbine steel tower ring segment.

It is furthermore preferable for the segment angle and the bracket angle to be of substantially equal magnitude. The bracket element thus has a form which corresponds to the first end portion and to the second end portion. In particular, the first bracket portion may be arranged substantially parallel to the surface of the first wind turbine steel tower ring segment, in particular to the first end portion, and the second bracket portion may be arranged substantially parallel to the surface of the second wind turbine steel tower ring segment, in particular to the second end portion. It is consequently possible to realize a particularly advantageous connection of the two wind turbine steel tower ring segments.

It is furthermore preferable for the first wind turbine steel tower ring segment and/or the second wind turbine steel tower ring segment and/or the bracket element to have fastening openings which are arranged and designed to receive fastening elements. In particular, it is preferable for the fastening elements to be designed as screws. The fastening openings on the first wind turbine steel tower ring segment and/or on the second wind turbine steel tower ring segment and/or on the bracket element are preferably arranged vertically adjacent to one another. In particular, the fastening openings of the bracket element are arranged correspondingly to the fastening openings of the first wind turbine steel tower ring segment and/or of the second wind turbine steel tower ring segment. This means in particular that the bracket element has a hole pattern which is configured correspondingly to the hole pattern of the two wind turbine steel tower ring segments.

The fastening opening on the first wind turbine steel tower ring segment and on the second wind turbine steel tower ring segment and on the bracket element are in particular arranged and designed such that the second wind turbine steel tower ring segments and the bracket element can be connected, wherein the fastening openings preferably have a radially oriented passage opening. It is furthermore preferable for the fastening portion of the connection element to have a through opening corresponding to the fastening openings, such that, for example, a fastening element can be passed through the fastening opening of the first wind turbine steel tower ring segment, through a fastening opening of the bracket element, and finally also through the through opening of the connection element, such that the bracket element, the connection element and the first wind turbine steel tower ring segment are fixedly connected to one another.

According to a further preferred design variant of the wind turbine steel tower portion, provision is made whereby the spacing of the fastening openings in an upper bracket end portion, which faces toward the upper horizontal end, and/or in a lower bracket end portion, which faces toward the lower horizontal end, is smaller than the spacing of the fastening openings in a bracket central portion which is arranged between the upper bracket end portion and the lower bracket end portion.

In particular, it is preferable for the upper bracket end portion to be spaced apart from the upper horizontal end and/or for the lower bracket end portion to be spaced apart from the lower horizontal end. In particular, it is preferable for the aforementioned spacing to be more than 200 mm and/or more than 300 mm and/or more than 400 mm. In the bracket central portion, it is particularly preferable for the spacing of the fastening opening to amount to greater than 100 mm and/or greater than 150 mm and/or greater than 200 mm. In the upper bracket end portion and/or in the lower bracket end portion, the fastening openings are preferably spaced apart from one another by a minimum spacing.

According to a further aspect, provided is a wind turbine tower comprising two or more wind turbine steel tower portions according to at least one of the design variants described above arranged one above the other.

A particularly preferred design variant of the wind turbine tower provides for it to comprise a first wind turbine steel tower portion with a first horizontal joint side, a second wind turbine steel tower portion with a second horizontal joint side, and a horizontal bracket element, which is arranged at a horizontal joint and which is connected to the first wind turbine steel tower portion and to the second wind turbine steel tower portion, wherein the first wind turbine steel tower portion, with the first horizontal joint side, and the second wind turbine steel tower portion, with the second horizontal joint side, are arranged against one another at the horizontal joint. It is further preferred for the horizontal bracket element to have a projecting horizontal connection element for the arrangement of functional elements. In particular, it is preferable for the horizontal connection element to be designed analogously to the connection element of the wind turbine steel tower portion. Two or more vertically adjacent wind turbine steel tower ring segments are preferably connected to one another by means of the horizontal bracket element. In particular in the case of an offset arrangement of the wind turbine steel tower ring segments, it is for example possible for a wind turbine steel tower ring segment of a first wind turbine steel tower portion to be connected to two or more wind turbine steel tower ring segments of a second wind turbine steel tower portion arranged adjacent to the first wind turbine steel tower portion. In particular, it is preferable for the horizontal bracket elements to extend in a circumferential direction.

The connection of two vertically adjacent wind turbine steel tower portions is preferably realized in single-shear, double-shear and/or multi-shear form. The single-shear connection means in particular that exactly one horizontal bracket element is arranged at a horizontal joint. In the case of the double-shear connection, exactly two horizontal bracket elements are arranged at a horizontal joint. It is furthermore also possible for multiple horizontal bracket elements to be arranged at a horizontal joint, wherein it is particularly preferable for in each case one horizontal bracket element to extend substantially between two bracket elements. The horizontal bracket elements preferably have an extent of less than 15 meters, in particular less than 13 meters, in order to meet the logistics requirements of a standard transport.

According to a further aspect, provided is a wind turbine tower comprising at least one above-described wind turbine steel tower portion, and at least one shell steel tower ring segment with a shell segment with an extent in the direction of a shell segment height, of a shell segment ring direction and of a shell segment thickness and with a first shell horizontal joint side and a second shell horizontal joint side, a first shell vertical joint side and a second shell vertical joint side, wherein a first shell vertical flange is arranged at the first shell vertical joint side and/or a second shell vertical flange is arranged at the second shell vertical joint side, wherein the first shell vertical flange and/or the second shell vertical flange encloses or enclose an angle with the shell segment, wherein at least one connection element for the arrangement of functional elements is formed on the first shell vertical flange and/or on the second shell vertical flange, wherein the connection element projects from the first shell vertical flange and/or from the second shell vertical flange, and wherein, preferably, the at least one shell segment is arranged so as to face toward a tower tip of the wind turbine tower and the at least one wind turbine steel tower portion is arranged so as to face away from the tower tip.

The shell steel ring segment preferably corresponds in terms of its configurations and details to the steel tower ring segment described in the German patent application “Wind turbine steel tower ring segment and method” from the same applicant and dated Jul. 26, 2017. Said application is fully incorporated herein by reference.

The wind turbine tower with at least one above-described wind turbine steel tower portion and with at least one shell steel tower ring segment makes it possible to combine the advantages of the two configurations with one another. In particular in the regions in which the wind turbine tower is subjected to particularly high loads, which is generally the case in the lower region, it is preferable to use an above-described steel tower portion. In particular in the regions in which the wind turbine tower is subjected to relatively low loads, which is generally the case in the upper region, it is preferable to use a shell steel tower ring segment.

In particular, it is preferable for the wind turbine tower to have, in addition to the at least one above-described wind turbine steel tower portion, a wind turbine tower portion which comprises at least a first shell steel tower ring segment and a second shell steel tower ring segment, wherein the first shell steel tower ring segment and the second shell steel tower ring segment abut against one another by way of vertical flanges at at least one substantially vertical joint, and wherein the first shell steel tower ring segment and the second shell steel tower ring segment are connected to one another at the at least one substantially vertical joint.

Provided is a wind turbine comprising a wind turbine tower according to the preceding aspect.

Furthermore, provided is a method for producing a wind turbine steel tower portion, in particular a wind turbine steel tower portion according to at least one of the design variants described above, comprising providing a first wind turbine steel tower ring segment with a first vertical joint side, a second wind turbine steel tower ring segment with a second vertical joint side and a bracket element, arranging the first wind turbine steel tower ring segment and the second wind turbine steel tower ring segment at a vertical joint with the first vertical joint side and the second vertical joint side, arranging the bracket element at the vertical joint, connecting the bracket element to the first wind turbine steel tower ring segment and to the second wind turbine steel tower ring segment.

It is further preferable for the method to comprise connecting the bracket element to the first wind turbine steel tower ring segment and to the second wind turbine steel tower ring segment by means of fastening elements, in particular screws. The method according to the invention and its possible developments have features or method steps that make them particularly suitable for being used for a wind turbine steel tower portion according to the invention and its developments. For further advantages, design variants and design details of these further aspects and their possible developments, reference is also made to the description given above with regard to the corresponding features and developments of the wind turbine steel tower portion.

### BRIEF DESCRIPTION OF THE SEVERAL VIEWS OF THE DRAWINGS

Preferred embodiments of the invention will be discussed by way of example on the basis of the appended figures. In the figures:

FIG. 1 shows a schematic three-dimensional view of an exemplary embodiment of a wind turbine;

FIG. 2 shows a schematic two-dimensional view of an exemplary embodiment of a wind turbine steel tower portion;

FIG. 3 shows a schematic two-dimensional view of a further exemplary embodiment of a wind turbine steel tower portion;

FIG. 4 shows a schematic two-dimensional view of a further exemplary embodiment of a wind turbine steel tower portion;

FIG. 5 shows a schematic two-dimensional view of an exemplary embodiment of a bracket element;

FIG. 6 shows a schematic three-dimensional partial view of an exemplary embodiment of a wind turbine steel tower portion;

FIG. 7 shows a schematic three-dimensional partial view of a further exemplary embodiment of a wind turbine steel tower portion;

FIG. 8 shows a schematic three-dimensional view of an exemplary embodiment of a wind turbine tower; and

FIG. 9 shows a schematic two-dimensional partial view of an exemplary embodiment of a further wind turbine tower.

In the figures, identical or substantially functionally identical or similar elements are denoted by the same reference designations.

### DETAILED DESCRIPTION

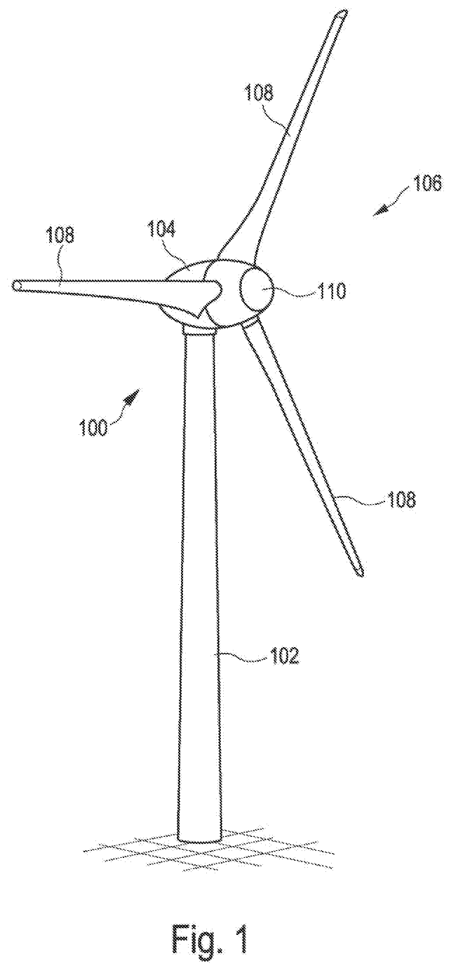

FIG. 1 shows a schematic three-dimensional view of an exemplary embodiment of a wind turbine. FIG. 1 shows in particular a wind turbine 100 with a tower 102 and a nacelle 104. A rotor 106 having three rotor blades 108 and having a spinner 110 is arranged on the nacelle 104. During operation, the rotor 106 is set in rotational motion by the wind and in this way drives a generator (not shown) at the nacelle 104. The tower 102 comprises in particular a plurality of wind turbine steel tower portions with a first wind turbine steel tower ring segment with a first vertical joint side and with a second wind turbine steel tower ring segment with a second vertical joint side, wherein these are arranged against one another at a vertical joint and are connected by means of a bracket element.

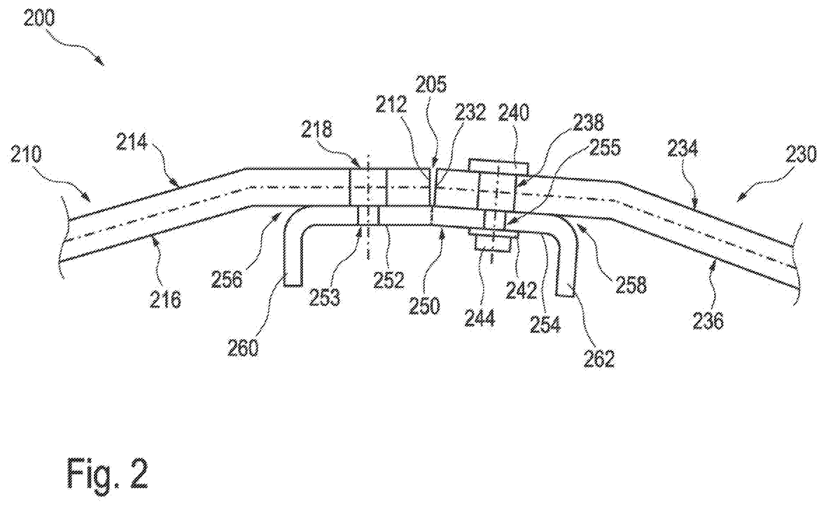

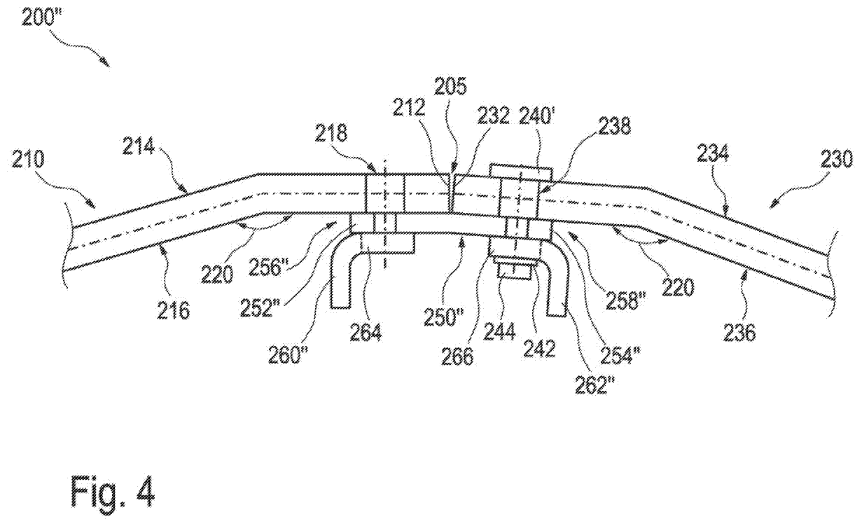

FIGS. 2 to 4 show steel tower portions 200, 200′, 200″ which differ in particular with regard to the design of the bracket element 250, 250′, 250″. The steel tower portions 200, 200′, 200″ have a first steel tower ring segment 210 and a second steel tower ring segment 230. The first steel tower ring segment 210 is arranged with its first vertical joint side 212 at the second vertical joint side 232 of the second steel tower ring segment 230 at a joint 205. The first steel tower ring segment 210 and the second steel tower ring segment 230 each have a part-ring-shaped cross section, wherein a surface normal of said cross section is oriented substantially parallel to the segment height, in this case orthogonally with respect to the plane of the drawing, wherein the part-ring-shaped cross section is formed by a number of straight portions, wherein the straight portions enclose a bend angle 220. The first steel tower ring segment 210 has an outer circumferential surface 214 and an inner circumferential surface 216. Analogously to this, the second steel tower ring segment 230 has an outer circumferential surface 234 and an inner circumferential surface 236. FIG. 4 furthermore shows the bend angle 220 between two straight portions of the first steel tower ring segment 210. The bend angle 220 amounts to preferably 175°. The straight portions of the steel tower ring segments, which adjoin the vertical joint sides 212, 232, enclose the segment angle, which likewise amounts to preferably 175°.

In a portion adjacent to the first vertical joint side 212, the first steel tower ring segment 210 has fastening openings 218, the passage direction of which is oriented substantially radially. Analogously to this, the second steel tower ring segment 230 has a fastening opening 238.

The bracket element 250 shown in FIG. 2 is arranged so as to connect the first steel tower ring segment 210 and the second steel tower ring segment 230 to one another. The bracket element 250 has a first bracket portion 252, which is arranged substantially on the first steel tower ring segment 210. Furthermore, the bracket element 250 has a second bracket portion 254, which is arranged substantially on the second steel tower ring segment 230. The dashed line between the first bracket portion and the second bracket portion 252, 254 is shown only for the purposes of identifying these two portions. The bracket element 250 shown is formed as an integral component.

Fastening openings 253 are furthermore arranged on the first bracket portion 252, and fastening openings 255 are arranged on the second bracket portion 254, said fastening openings being formed correspondingly to the fastening openings 218, 238 of the steel tower ring segments 210, 230. The bracket element 250 is connected to the first steel tower ring segment 210 and to the second steel tower ring segment 230 by means of a screw connection, which is shown by way of example for the connection of the bracket element 250 to the second steel tower ring segment 230. For this purpose, a screw 240 is led from the outer circumferential surface 234 through the fastening opening 238 of the second steel tower ring segment 230 and the fastening opening 255 of the bracket element 250 and is secured by means of a washer 242 and a nut 244.

In the horizontal direction or in the circumferential direction of the steel tower portion 200, 200′, 200″, the bracket element 250 extends from a first vertical end 256 to a second vertical end 258. A first connection element 260 is furthermore arranged at the first vertical end 256, and a second connection element 262 is arranged at the second vertical end 258. The connection elements 260, 262 project from the bracket element 250 and each enclose a connection angle with the bracket element. In the present case, this connection angle amounts to approximately 90°. Furthermore, the connection elements project in a connection direction which is oriented substantially radially.

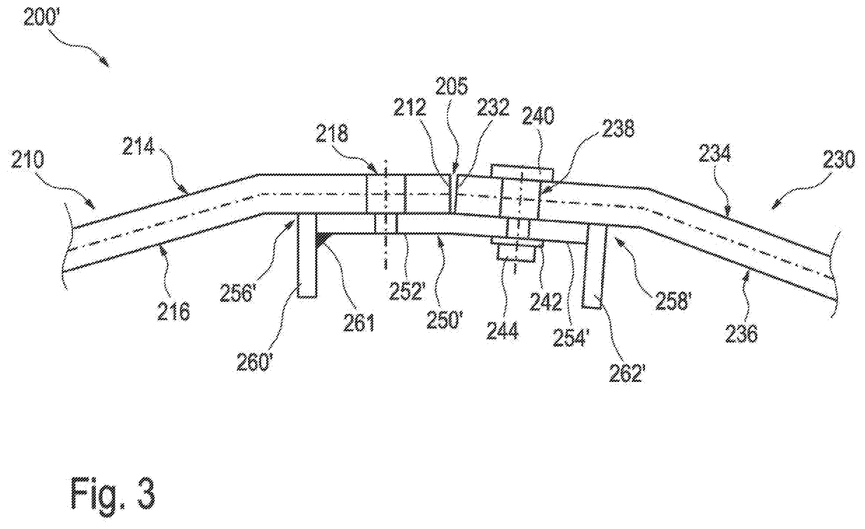

The bracket element 250′ shown in FIG. 3 likewise extends from a first vertical end 256′ to a second vertical end 258′, wherein connection elements 260′, 262′ are arranged in each case on the vertical ends 256′, 258′. The connection elements 260′, 262′ are arranged on the bracket element 250′ by means of a welded connection. The connection elements 260′, 262′ are thus initially formed as separate components, which are arranged on the bracket element 250′ and connected to the latter. In the present case, the connection elements 260′, 262′ are welded on, which is shown schematically by means of the weld seam 261.

The bracket element 250″ shown in FIG. 4 likewise extends from a first vertical end 256″ to a second vertical end 258″, wherein connection elements 260″, 262″ are arranged on these ends or on portions adjacent to these vertical ends. The connection elements 260″, 262″ have fastening portions 264, 266, to which the connection elements 260″, 262″ are integrally connected. The fastening portions 264, 266 are arranged substantially parallel to the surface of the bracket element 250″ and are bent at a 90° angle with respect to the connection elements 260″, 262″. The fastening portions 264, 266 also have passage openings which are arranged correspondingly to the fastening openings 253, 255 of the bracket element 250″ and to the fastening openings 218, 238 of the first steel tower ring segment 210 and of the second steel tower ring segment 230, for the purposes of connecting the components to one another by means of a screw 240′.

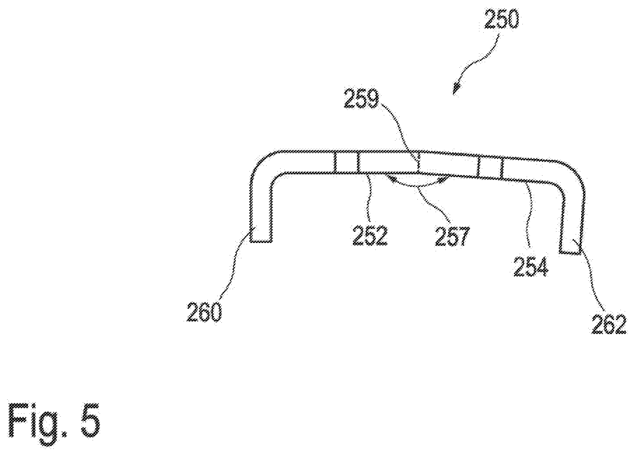

FIG. 5 shows the bracket element 250 from FIG. 2 in detail. In particular, the bracket angle 257 between the first bracket portion 252 and the second bracket portion 254 can be seen. The bracket angle 257 amounts to preferably likewise 5°. In particular, it is preferable for the segment angle between two adjacent steel tower ring segments 210, 230 and the bracket angle 257 to be of equal magnitude. On the side opposite the side on which the bracket angle 257 is enclosed, an apex 259 is formed, which is arranged at the joint 205.

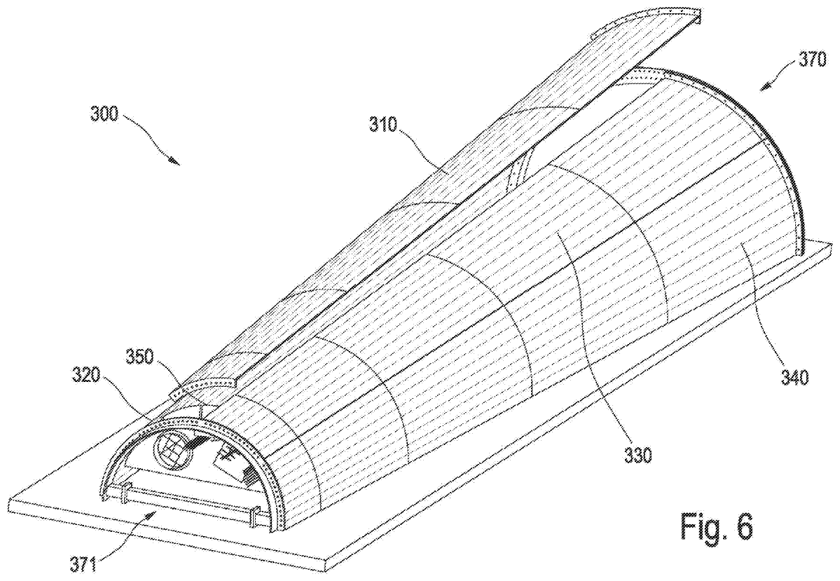

FIG. 6 shows a schematic three-dimensional partial view of an exemplary embodiment of a wind turbine steel tower portion. The steel tower portion 300 has a first steel tower ring segment 310, a second steel tower ring segment 320, a third steel tower ring segment 330 and a fourth steel tower ring segment 340. In the longitudinal direction, the steel tower portion extends with a segment extent from a lower horizontal joint side 370 to an upper horizontal joint side 371. The steel tower ring segments 310, 320, 330, 340 are each connected to one another by means of a bracket element 350.

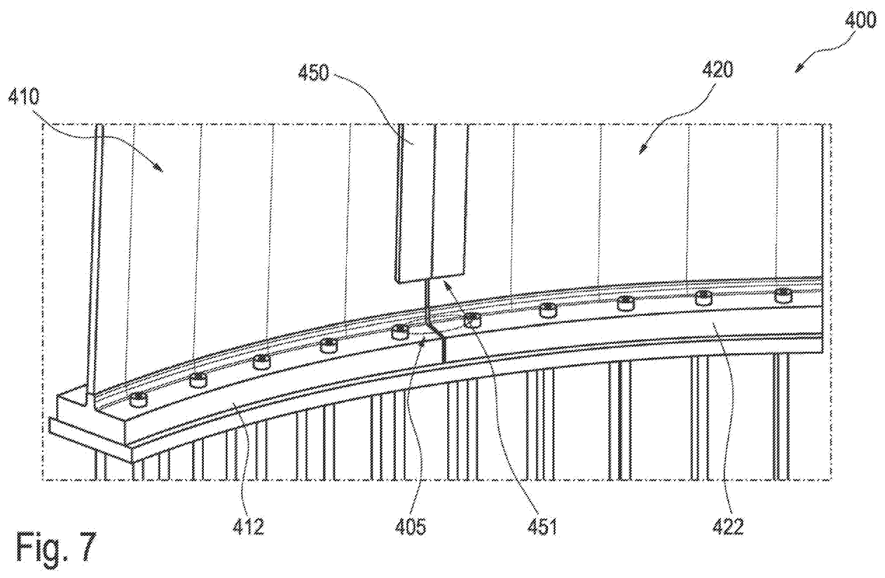

FIG. 7 shows a schematic, three-dimensional partial view of a further exemplary embodiment of a wind turbine steel tower portion 400, wherein the connection elements are arranged in a portion of the bracket element 450 which is not shown. The first steel tower ring segment 410 and the second steel tower ring segment 420 are arranged against one another at a vertical joint 405 and are connected to one another by means of the bracket element 450. The lower horizontal joint side of the first steel tower ring segment 410 is formed by means of a first vertical flange 412 and the lower horizontal joint side of the second steel tower ring segment 420 is formed by a second vertical flange 422.

It can be seen that the lower horizontal end 451 of the bracket element 450 is arranged spaced apart from the lower horizontal joint sides of the steel tower ring segments 410, 420. A gap between the first steel tower ring segment 410 and the second steel tower ring segment 420 and between the first vertical flange 412 and the second vertical flange 422 is preferably sealed. In particular, it is preferable for an elastic, in particular flexible, seal to be attached, in a vertical direction below the bracket element 450, to the two steel tower ring segments 410, 420. This seal can be regarded as an elongation of the bracket element 450. This seal preferably extends from the bracket element 450 as far as and so as to include the vertical flanges 412, 422. The seal is advantageously arranged so as to cover the gap. The seal may be designed as a rubber seal, wherein a thickness of 3 to 4 mm is particularly preferred. It is furthermore preferable for the seal to be adhesively bonded on in the portion discussed above, in particular adhesively bonded on at one side.

By means of the configuration according to FIG. 7, it is furthermore the case that holes in weld seams are avoided and, furthermore, there is no interruption in the bracket at weld seams. In this case, too, fastening openings (not shown) are provided which have a smallest possible spacing in an upper bracket end portion and/or in a lower bracket end portion, wherein, in particular, four fastening openings are provided per bracket end portion.

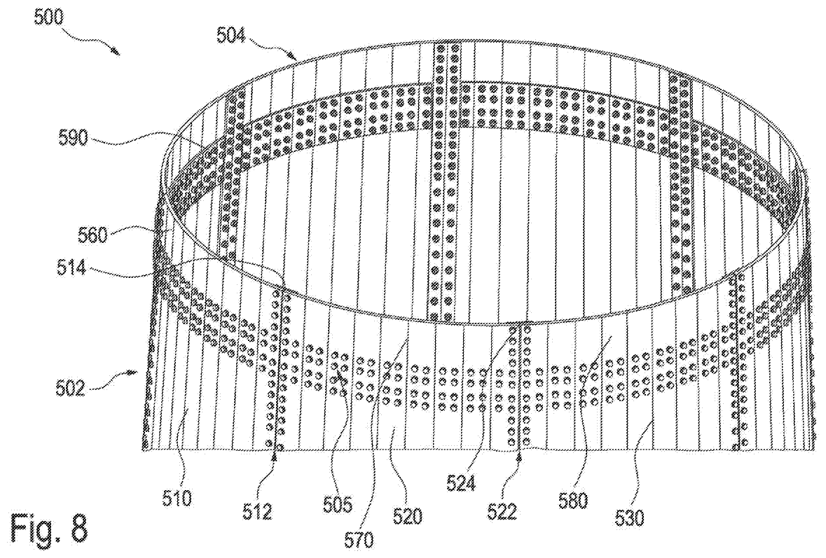

FIG. 8 shows a schematic three-dimensional view of an exemplary embodiment of a wind turbine tower. The tower 500 has a first wind turbine steel tower portion 502 with a total of eight horizontally adjacent steel tower ring segments, in particular with a first steel tower ring segment 510, a second steel tower ring segment 520 and a third steel tower ring segment 530. The first steel tower ring segment 510 is arranged against the second steel tower ring segment 520 at a vertical joint 512. On the inner circumferential surface of the first and second steel tower ring segments 510, 520, there is arranged a bracket element (not shown) which is connected to the steel tower ring segments 510, 520 by means of screws, of which only the screw heads can be seen here. The second steel tower ring segment 520 and the third steel tower ring segment 530 are arranged against one another at a further vertical joint 522 and are connected to the inner circumferential surface of the tower 500 by means of a bracket element (not shown). Arranged vertically adjacently above the first wind turbine steel tower portion 502 is a second wind turbine steel tower portion 504, which likewise has eight horizontally adjacent steel tower ring segments, in particular a fourth steel tower ring segment 560, a fifth steel tower ring segment 570 and a sixth steel tower ring segment 580. The fourth steel tower ring segment 560 and the fifth steel tower ring segment 570 are connected to one another by means of a bracket element 514. Furthermore, the fifth steel tower ring segment 570 and the sixth steel tower ring segment 580 are connected to one another by means of a bracket element 524. The connection elements are not shown in this schematic drawing.

Furthermore, it is shown that the vertically adjacent wind turbine steel tower portions 502, 504 each have a horizontal joint side, by means of which the wind turbine steel tower portions 502, 504 abut against one another at a horizontal joint 505. To connect the wind turbine steel tower portions 502, 504, eight horizontal bracket elements, for example the horizontal bracket elements 590, are arranged at the horizontal joint and are connected to the first wind turbine steel tower portion 502 and to the second wind turbine steel tower portion 504. The horizontal bracket element 590 may extend in ring-shaped or part-ring-shaped fashion in the circumferential direction. In particular, it is preferable for the horizontal bracket element 590 to extend in the circumferential direction between two bracket elements 514, 524. Furthermore, a total of eight horizontal bracket elements may be arranged in each case between two of the eight bracket elements.

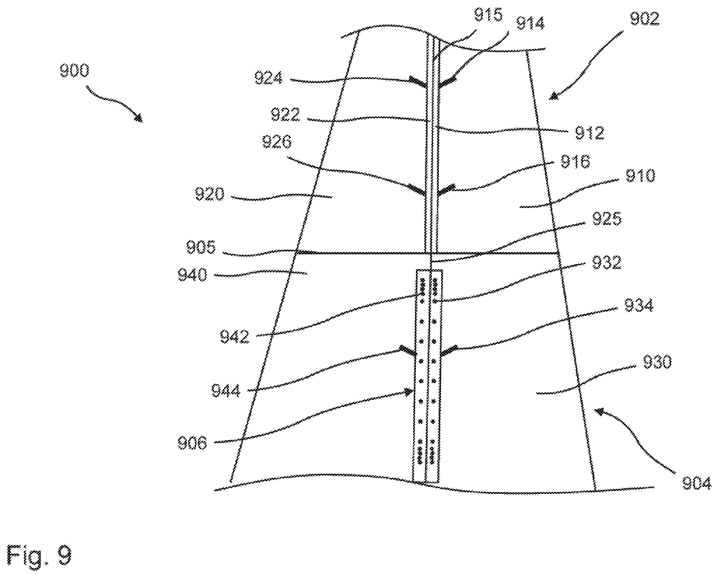

FIG. 9 shows a schematic two-dimensional partial view of an exemplary embodiment of a further wind turbine tower. The tower 900 comprises an upper tower portion 902, which faces toward a tower tip of the tower 900, and a lower tower portion 904, which faces away from the tower tip of the tower 900. The upper tower portion 902 and the lower tower portion 904 abut against one another at a horizontal joint 905 and are connected to one another in the region of the horizontal joint 905.

The upper tower portion 902 is designed in particular as a wind turbine tower portion with a first and a second shell steel tower ring segment. The first and second shell steel tower ring segments will be referred to below for short as first and second steel tower ring segments. The first steel tower ring segment 910 has a first vertical joint side and the second steel tower ring segment 920 has a second vertical joint side. The first steel tower ring segment 910 and the second steel tower ring segment 920 are arranged horizontally adjacent to one another. The first steel tower ring segment 910 and the second steel tower ring segment 920 abut against one another with their vertical joint sides at an upper vertical joint 915.

A first vertical flange 912 is arranged on the first steel tower ring segment 910 on the first vertical joint side. Analogously, a second vertical flange 922 is arranged on the second steel tower ring segment 920 on the second vertical joint side. The vertical flanges 912, 922 each enclose an angle with the wall-forming portions of the steel tower ring segments 910, 920. On the vertical flanges 912, 922, there are arranged horizontally oriented passage openings (not shown). The passage openings are in particular arranged and designed such that the vertical flanges 912, 922 are connectable to one another by means of fastening elements. By connecting the vertical flanges 912, 922 to one another, the steel tower ring segments 910, 920 are also connected to one another.

A first connection element 914 and a second connection element 916 are formed on the first vertical flange 912 and project from the first vertical flange 912. The connection elements 914, 916 and also all further connection elements described below are arranged and designed in particular for the arrangement of functional elements. Likewise, two connection elements 924, 926 are formed on the second vertical flange 922 and project from the second vertical flange 922.

The lower tower portion 904 comprises a third steel tower ring segment 930 and a fourth steel tower ring segment 940. The third steel tower ring segment 930 and the fourth steel tower ring segment 940 abut against one another with their respective vertical joint sides at a lower vertical joint 925. Arranged at the lower vertical joint 925 is a bracket element 906 which is connected to the third steel tower ring segment 930 and to the fourth steel tower ring segment 940. The connection is realized in particular with fastening elements 932, 942, wherein the vertical spacing of the fastening elements is greater in a central portion of the bracket element 906 than in the two end portions of the bracket element 906. In the end portions of the bracket element 906, the vertical spacing of the fastening elements is rather chosen to be as small as possible. The third steel tower ring segment 930 and the fourth steel tower ring segment 940 are thus connected to one another and held together at the lower vertical joint 925 by the bracket element 906. The lower tower portion 904 likewise has connection elements 934, 944, wherein the bracket element 906 has the connection elements 934, 944. The connection elements 934, 944 project from the bracket element 906.

The bracket element 250, 250′, 250″, 350, 450, 514, 524 with a projecting connection element 260, 260′, 260″, 262, 262′, 262″ has the particular advantage of a particularly inexpensive connection of two steel tower ring segments 210, 230, 310, 320, 410, 420, 510, 520, 530, wherein it is furthermore particularly advantageously possible for functional elements to be arranged in the interior of the tower 102, 500 but also on the outside of the tower 102, 500, without the need for welding into the supporting structure, in particular the shell elements of the steel tower ring segments 210, 230, 310, 320, 410, 420, 510, 520, 530. As a result, the steel tower ring segments 210, 230, 310, 320, 410, 420, 510, 520, 530 can be connected to one another particularly easily at a construction site, since they exhibit no or reduced distortion. Furthermore, the tower 102, 500 is in a predetermined stress state, without scarcely predictable stress states arising as a result of welding.

### REFERENCE DESIGNATIONS

100 Wind turbine
102, 500 Tower
104 Nacelle
106 Rotor
108 Rotor blades
110 Spinner
200, 200′, 200″, 300, Steel tower portion
400, 502, 504
205, 405, 512, 522 Joint
210, 310, 410, 510 First steel tower ring segment
212 First vertical joint side
214, 234 Outer circumferential surface
216, 236 Inner circumferential surface
218, 238, 253, 255 Fastening opening
220 Bend angle
230, 320, 420, 520 Second steel tower ring segment
232 Second vertical joint side
240, 240′ Screw
242 Washer
244 Nut
250, 250′, 250″, 350, Bracket element
450, 514, 524
252, 252′, 252″ First bracket portion
254, 254′, 254″ Second bracket portion
256, 256′, 256″ First vertical end
257 Bracket angle
258, 258′, 258″ Second vertical end
259 Apex
260, 260′, 260″ First connection element
261 Weld seam
262, 262′, 262″ Second connection element
264, 266 Fastening portion
330, 340, 530, 560, Steel tower ring segment
570, 580
370 Lower horizontal joint side
371 Upper horizontal joint side
412, 422 Vertical flange
451 Lower horizontal end
505 Horizontal joint
590 Horizontal bracket element
900 Tower
902 Upper tower portion
904 Lower tower portion
905 Horizontal joint
906 Bracket element
910 First steel tower ring segment
912 First vertical flange
914 First connection element
915 Upper vertical joint
916 Second connection element
920 Second steel tower ring segment
922 Second vertical flange
924 Third connection element
925 Lower vertical joint
926 Fourth connection element
930 Third steel tower ring segment
932 Fastening element
934 Fifth connection element
940 Fourth steel tower ring segment
942 Fastening element
944 Sixth connection element

1. A wind turbine steel tower portion for a wind turbine tower, comprising:
a first wind turbine steel tower ring segment with a first vertical joint side;
a second wind turbine steel tower ring segment with a second vertical joint side;
a bracket arranged at a joint, wherein the bracket is connected to the first wind turbine steel tower ring segment and to the second wind turbine steel tower ring segment;
wherein the first wind turbine steel tower ring segment, with the first vertical joint side, and the second wind turbine steel tower ring segment, with the second vertical joint side, are arranged together at the joint; and
wherein the bracket has a connection element that projects from the bracket and the connection element is configured to receive an arrangement of functional elements.

2. The wind turbine steel tower portion as claimed in claim 1, wherein:
the bracket and the connection element enclose form a connection angle, and
the connection element projects in a projecting direction and the projecting direction is oriented substantially radially.

3. The wind turbine steel tower portion as claimed in claim 1, wherein:
the connection element is formed as a single piece with the bracket, or
the connection element is connected to the bracket.

4. The wind turbine steel tower portion as claimed in claim 1, wherein:
the connection element is connected to the bracket by welding, or
the connection element is connected to the bracket by at least one fastening element.

5. The wind turbine steel tower portion as claimed in claim 1, wherein:
the connection element has a fastening portion.

6. The wind turbine steel tower portion as claimed in claim 1, wherein:
the bracket extends from a first vertical end to a second vertical end, and from an upper horizontal end to a lower horizontal end,
the connection element includes a first connection element and a second connection element, wherein the first connection element is arranged at the first vertical end and the second connection element is arranged at the second vertical end,
the first connection element and the second connection element have a same spacing between a first upper horizontal joint side and a first lower horizontal joint side of the first wind turbine steel tower ring segment and a same spacing between a second upper horizontal joint side and a second lower horizontal joint side of the second wind turbine steel tower ring segment.

7. The wind turbine steel tower portion as claimed in claim 1, wherein the bracket is arranged on an inner circumferential surface or an outer circumferential surface of the first wind turbine steel tower ring segment and the second wind turbine steel tower ring segment.

8. The wind turbine steel tower portion as claimed in claim 1, wherein:
the bracket has a first bracket portion arranged substantially on the first wind turbine steel tower ring segment and a second bracket portion arranged substantially on the second wind turbine steel tower ring segment, and
wherein the first bracket portion and the second bracket portion enclose a bracket angle.

9. The wind turbine steel tower portion as claimed in claim 1, wherein:
the bracket a length extending in a direction that is substantially parallel to a segment height, and wherein the length of the bracket is more than 20% of the segment height.

10. The wind turbine steel tower portion as claimed in claim 8, wherein:
the first bracket portion is arranged on a first end portion of the first wind turbine steel tower ring segment, wherein the first end portion adjoins the first vertical joint side,
the second bracket portion is arranged on a second end portion of the second wind turbine steel tower ring segment, wherein the second end portion adjoins the second vertical joint side, and
the first end portion and the second end portion enclose a segment angle.

11. The wind turbine steel tower portion as claimed in claim 1, wherein the segment angle and the bracket angle are of substantially equal amounts.

12. The wind turbine steel tower portion as claimed in claim 1, wherein the first wind turbine steel tower ring segment, the second wind turbine steel tower ring segment, and have fastening openings configured to receive fastening elements.

13. The wind turbine steel tower portion as claimed in claim 1, wherein a spacing of the fastening openings in an upper bracket end portion, which faces toward the upper horizontal end, and in a lower bracket end portion, which faces toward the lower horizontal end, is smaller than the spacing of the fastening openings in a bracket central portion which is arranged between the upper bracket end portion and the lower bracket end portion.

14. A wind turbine tower comprising two or more wind turbine steel tower portions as claimed in claim 1 arranged one above the other.

15. A wind turbine comprising a wind turbine tower as claimed in claim 14.

16. A method for producing a wind turbine steel tower portion as claimed in claim 1, the method comprising:
arranging a first wind turbine steel tower ring segment and a second wind turbine steel tower ring segment at forming a joint with a first vertical joint side of the first wind turbine steel tower ring segment and a second vertical joint side of the second wind turbine steel tower segment ring;
arranging the bracket at the joint; and
connecting the bracket to the first wind turbine steel tower ring segment and the second wind turbine steel tower ring segment.

17. The method as claimed in claim 16, wherein the wind turbine steel tower portion is part of a wind turbine steel tower.

18. The wind turbine steel tower portion as claimed in claim 5, wherein the connection element is connected to the fastening portion or the connection element is formed as a single piece with the fastening portion.
